(19) United States
(12) Patent Application Publication
(10) Pub. No.: US 2025/0101301 A1
(43) Pub. Date: Mar. 27, 2025

(54) INDICATOR COMPOSITION FOR APPLICATION CONTROL

(71) Applicant: Polysecure GmbH, Freiburg (DE)

(72) Inventors: Maziar MATLOUBIGHARAGOZLOO, Freiburg (DE); Daniel KIRCHENBAUER, Freiburg (DE); Jochen MÖßLEIN, Freiburg (DE); Abdelaziz AL OUAHABI, Freiburg (DE); Guojun GAO, Freiburg (DE)

(73) Assignee: Polysecure GmbH, Freiburg (DE)

(21) Appl. No.: 18/580,800

(22) PCT Filed: Jul. 27, 2022
(86) PCT No.: PCT/DE2022/100543

§ 371 Date: Jan. 19, 2024

(30) Foreign Application Priority Data
Jul. 27, 2021 (DE) 10 2021 119 428.8

(51) Int. Cl. C09K 11/77; G01N 21/77; G01N 31/22

(52) U.S. Cl. CPC C09K 11/7701; G01N 21/77; G01N 31/22

(57) ABSTRACT

The present invention relates to an application control composition comprising an indicator, wherein the indicator is modifiable and comprises at least one organic compound having a conjugated binding system, an organometallic compound or an inorganic compound. It further relates to an application control method and to the use of the composition according to the invention.

The present invention relates to an application control composition comprising an indicator, wherein the indicator is modifiable and comprises at least one organic compound having a conjugated binding system, an organometallic compound or an inorganic compound. It further relates to an application control method and to the use of the composition according to the invention.

### STATE OF THE ART

In various fields of application, surfaces are treated with a liquid by applying it to the surface. For example, cleaning and disinfection processes may be mentioned. Here, it is often relevant to determine whether the surface has been treated at least partially or completely, which period of time has elapsed since then or whether the condition of the surface has changed since the application, e.g., the surface has been contaminated.

Known compositions can have a permanent indicator, which can have e.g. fluorescence. It is disadvantageous that the known indicators do not make it possible to control which period of time has elapsed since the application.

It is therefore the object of the present invention to provide a composition which overcomes the existing disadvantages and enables reliable application control.

This object is surprisingly achieved by an application control composition comprising an indicator, wherein the indicator is modifiable and comprises at least one organic compound having a conjugated binding system, an organometallic compound or an inorganic compound.

A modifiable indicator changes its optical properties, e.g., its emission and/or absorption properties, over time or by an external influence.

Conjugated binding systems have an overlap of π bonds. Examples are conjugated double bond systems and π bond systems.

An organometallic compound has a metal center and an organic cage having a conjugated π bond system, which can serve as a sensitizer.

Preferably, the at least one organic compound having a conjugated binding system or the organometallic compound is a fluorophore.

Particularly preferably, the conjugated binding system can be aliphatic or aromatic.

Preferred organic compounds having a conjugated binding system are quinine and derivatives thereof, hydroxycoumarins and derivatives thereof, complexes of tryptophan with metals, in particular lanthanides having atomic number 57 to 71; and mixtures thereof.

Preferred lanthanides are europium, terbium, lanthanum, samarium and mixtures thereof.

Preferred organometallic compounds are complexes of tryptophan with metals, in particular lanthanides having atomic number 57 to 71.

A preferred inorganic compound is lanthanum oxide.

The lanthanum oxide can particularly preferably be doped. Particularly preferably, the lanthanum oxide can be doped with ytterbium or ytterbium and erbium or ytterbium and holmium or ytterbium and thulium.

The lanthanum oxides doped with ytterbium can be excited with infrared light. Lanthanum oxide doped with ytterbium is a downconverter. Lanthanum oxides doped with ytterbium and erbium or ytterbium and holmium or ytterbium and thulium are both upconverters and downconverters.

Preferably, the composition is in the form of a solution, dispersion or suspension.

In a preferred embodiment, the indicator is introduced into the solution, dispersion or suspension only during the application.

Preferably, the indicator can be modified by means of electromagnetic radiation, such as UV radiation, IR radiation, visible light; a pH change, a temperature change, an oxidizing agent, a reducing agent and/or contact with a biological organism.

Preferably, the indicator is modified by the breaking of an envisaged chemical bond and the subsequent formation of at least two degradation compounds having differing optical properties, which differ from the optical properties of the indicator. Particularly preferably, the envisaged chemical bond can comprise a carbonyl bond (—C(═O)—). Very particularly preferably, the envisaged bond can be a carbonate or carbamate bond.

Likewise preferably, the indicator is modified by a chemical conversion, such as an oxidation, a photooxidation, a complexation, a ligand exchange, a ligand cleavage from a metal center, a rearrangement, an oligomerization, a conformational rearrangement, a racematization, a protonation, a deprotonation, a contact with water, in particular a hydration and/or enzymatic conversion of the indicator; to a compound having differing optical properties.

Preferred electromagnetic radiation are UV radiation, IR radiation or visible light.

Preferably, the pH changes from 1, 2, 3, 4, 5, 6, 7, 8, 9, 10, 11, 12, 13 or 14 to 1, 2, 3, 4, 5, 6, 7, 8, 9, 10, 11, 12, 13 or 14. Particularly preferably, the pH changes between acidic (pH≤6.5), neutral (pH 6.5 to 7.4) and alkaline (pH≥7.5).

Preferably, the temperature change is in the range from 0 to 100° C., particularly preferably 15 to 50° C. In particular, the indicator can be modified by a temperature difference of 1-5° C., 5-10° C., 10-20° C., 20-30° C. or more than 30° C. or up to 300° C.

Preferred oxidizing agents are air, oxygen, peroxides, such as hydrogen peroxide; and mixtures thereof.

Preferably suitable biological organisms are bacteria, such as amycolatopsis. Saccharothrix and tritirachium; and fungi, such as yeasts.

Preferably, the at least one indicator is fluorescent or phosphorescent or the indicator has thermochromic properties.

Preferably, the at least one indicator can change its emission and/or absorption properties by the modification. Particularly preferred modifications of the emission and/or absorption properties are a modification of the emission intensity, of the emission spectrum, of the absorption spectrum, and/or of the absorption cross section.

The modification of the emission properties can comprise a modification of the luminescence properties. The luminescence behavior can be based on luminescent substances from the group of fluorescent materials and/or phosphorescent materials and/or upconverters and/or downconverters and/or materials which re-emit an excitation wavelength after excitation. Luminescence is understood to mean the emission of electromagnetic radiation after input of energy. In this case, it is preferred that the energy input is via photons, the observed luminescence thus being photoluminescence. The photoluminescence can occur in the UV and/or VIS and/or IR spectrum. Upconverters are luminescent substances which, after excitation, emit photons whose wavelength is shorter than the wavelength of the excitation photons. Downconverters are luminescent substances which, after excitation, emit photons whose wavelength is longer than the wavelength of the excitation photons.

Particularly preferably, the indicator can change its visible colour by the modification.

Preferably, the indicator can change its optical properties, such as e.g. its colour, its emission intensity, its emission spectrum and/or its excitation spectrum, within 1 second to 3 days, preferably 10 seconds to 24 hours, more preferably 10 seconds to 12 hours, particularly preferably 1 minute to 3 hours, most preferably 5 minutes to 1 hour. Likewise preferably, the indicator can change its optical properties, such as e.g. its colour, its emission intensity, its emission spectrum and/or its excitation spectrum, within 1 to 24 months, 1 to 30 days, 1 to 24 hours or 0.5 to 60 minutes. This enables the selection of an indicator on the basis of the envisaged intended use. Particularly preferably, no or no substantial modification of the indicator takes place in the case of darkness and/or airtight packaging. As a result, the composition according to the invention can be stored easily.

In one embodiment, the emission of the indicator is visible directly after the application and disappears from the visible range with increasing modification of the indicator. This enables the control whether e.g. a surface has been completely wetted.

It is further preferred if the modification of the indicator can take place reversibly, irreversibly or partially reversibly and partially irreversibly.

In a preferred embodiment, the composition can comprise a plurality of indicators with different emission properties before or after the start of the modification process.

In a further preferred embodiment, the composition can comprise a mixture of modifiable indicators and stable/unmodifiable indicators.

The composition according to the invention can be hydrophilic or hydrophobic.

The composition preferably comprises at least one solvent. Preferred solvents are water and organic solvents, in particular alcohols, such as methanol, ethanol and propanol, and mixtures thereof. Particularly preferred solvents are water, ethanol, propanol and mixtures thereof. A very particularly preferred solvent is water.

The composition can further preferably comprise further constituents, such as surfactants, biocides, fungicides, herbicides, dyes, fragrances, buffers and mixtures thereof.

Preferably, the composition comprises the at least one indicator in an amount by weight of 0.000001% by weight to 10% by weight, preferably 0.00001% by weight to 3% by weight, particularly preferably 0.0001% by weight to 1% by weight, particularly preferably 0.001% by weight to 0.5% by weight, particularly preferably 0.01% by weight to 0.3% by weight, most preferably 0.1 to 0.2% by weight, based on the weight of the total composition.

Preferably, the composition comprises at least one solvent in an amount by weight of 50% by weight to 99.9% by weight, preferably 60% by weight to 99% by weight, particularly preferably 70% by weight to 98% by weight, most preferably 80 to 95% by weight, based on the weight of the total composition.

Preferably, the composition comprises the abovementioned further constituents, such as surfactants, biocides, fungicides, herbicides, dyes, fragrances, buffers and mixtures thereof, in an amount by weight of 0.001% by weight to 10% by weight, preferably 0.01% by weight to 3% by weight, particularly preferably 0.1% by weight to 1% by weight, most preferably 0.3 to 0.5% by weight, based on the weight of the total composition.

It can be envisaged that the term “comprising” as used herein is “consisting of”, unless expressly mentioned otherwise. For example, a composition which is attributed to comprising one or more constituents can also be a composition which consists of the one or more constituents.

In a preferred embodiment, the composition according to the invention is a cleaning agent. As cleaning agent, the composition according to the invention can comprise additives as are customary for cleaning agents. For example, the indicator can have a green colour during application, so that it is possible to identify where cleaning agent has been applied. After the modification of the indicator, a colour change to red takes place, for example. It can hereby be determined, for example, that a certain period of time has elapsed since the last cleaning. Alternatively, the indicator is colourless in visible light and has an emission spectrum, e.g. after excitation in the UV range, which changes. In this case, the application can be checked as required, e.g. by means of a UV lamp.

In a further preferred embodiment, the composition according to the invention is a disinfecting agent. As disinfecting agent, the composition according to the invention can comprise substances and additives which are effective for disinfection, as are customary for disinfecting agents. For example, the indicator can have a green colour during application, so that it is possible to identify where disinfecting agent has been applied. After the modification of the indicator, a colour change to red takes place, for example. It can hereby be determined, for example, that a certain period of time has elapsed since the last disinfection. Alternatively, the indicator is colourless in visible light and has an emission spectrum, e.g. after excitation in the UV range, which changes. In this case, the application can be checked as required, e.g. by means of a UV lamp.

In another embodiment, the composition according to the invention is in the form of a concentrate. The concentrate can be added to a solution, in particular a cleaning agent or a disinfecting agent. Suitable cleaning and disinfecting agents are conventional cleaning and disinfecting agents. Preferably, the concentrate of the composition comprises the at least one indicator in an amount by weight of 0.00001% by weight to 100% by weight, preferably 0.00001% by weight to 50% by weight, particularly preferably 0.0001% by weight to 25% by weight, particularly preferably 0.001% by weight to 10% by weight, particularly preferably 0.01% by weight to 5.0% by weight, most preferably 0.1 to 1.0% by weight, based on the weight of the total composition as concentrate.

### METHOD

The present invention also relates to a method for controlling the quality of a composition according to the present invention, comprising:
determining at least one property of the composition, wherein the property is determined by means of qualitative and/or quantitative analysis; and
matching the determined property with a target value of the property,
   wherein the property of the composition is a property that changes under an external influence, wherein the external influence is preferably one selected from the group consisting of electromagnetic radiation, pH change, temperature change, presence of an oxidizing agent, presence of a reducing agent, contact with a biological organism, and two or more thereof.

The qualitative analysis can comprise checking the presence of an indicator or the presence of a particular indicator property (e.g. indicator colour or colour of the indicator fluorescence). The quantitative analysis can comprise determining an indicator quantity or the quantitative determination of an indicator property (e.g. emission intensity or determination of the emission spectrum).

It can hereby be checked whether the composition has already been exposed to an influence before its application, which has led to a modification of the indicator. A modification of the indicator can indicate improper storage and thus impaired quality of the composition.

The present invention also relates to a method for application control.

The method according to the invention comprises the steps of:
applying a composition according to the invention to a surface or an object;
checking the application by means of qualitative and/or quantitative analysis

The qualitative analysis can comprise checking the presence of an indicator or the presence of a particular indicator property (e.g. indicator colour or colour of the indicator fluorescence). The quantitative analysis can comprise determining an indicator quantity or the quantitative determination of an indicator property (e.g. emission intensity or determination of the emission spectrum).

The analysis can take place without technical aids, e.g. via a visual control. However, various detectors such as black-and-white cameras, colour cameras, photomultipliers, spectrometers, photocells, photodiodes, phototransistors alone or in combination can also be used for the analysis. Optical filters, such as e.g. long-pass/short-pass/bandpass filters, can be used in the detection devices.

Broad-band and/or narrow-band sources, such as e.g. lasers, laser diodes, light-emitting diodes (LEDs), xenon lamps, halogen lamps, can be used individually or in combination for the excitation of a luminescence. The excitation sources can be activated individually or simultaneously or sequentially in different combinations. Optical filters such as long-pass/short-pass/bandpass filters can be used in the excitation devices.

Preferably, the method comprises a first check of the application and at least one second check of the application at a later time.

In a preferred embodiment, the result of the check of the application of the composition according to the invention is compared with a colour scale or on the basis of a measured optical property or with a standardised composition, e.g. a freshly produced composition according to the invention. In this way, it can be established whether the modification process has already started or to what degree it has progressed. If appropriate, the period of time since application or the need for renewed application, e.g. renewed cleaning or disinfection, can also be established in this way.

### USE

Preferably, the compositions according to the invention can be used as cleaning or disinfecting agent, agricultural chemical, biocide, herbicide, pesticide, coating, production aid, flux, transmission or engine oil, brake fluid or chassis wax. Particularly preferably, the compositions according to the invention can be used as cleaning or disinfecting agent.

All combinations of preferred ranges or of embodiments are particularly preferred.

Further features and advantages of the invention emerge from the following detailed description of exemplary embodiments.

### EXEMPLARY EMBODIMENTS

All chemicals used were used as obtained by Sigma Aldrich (Germany), unless indicated else.

Toluene was dried by distillation over sodium in an argon atmosphere and dried over molecular sieve (4 Å) under argon.

All synthesized compounds were stored in a desiccator until further use.

### 1. Synthesis of an Indicator Based on Quinine

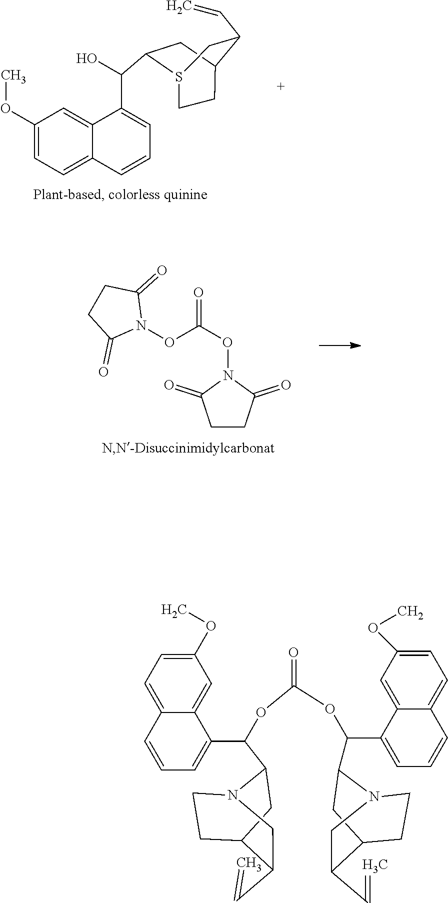

N,N′-disuccinic carbonate (DSC) and quinine were dried in vacuo for about 4 hours in separate 100 mL round-bottom flasks and then transferred to a 250 ml three-necked flask. The molar ratio of quinine to DSC was 2:1. The reagents were dissolved in 50 mL dry toluene under an argon atmosphere, heated to 90° C. with stirring with a KPG stirrer and refluxed for 12 hours. The temperature was then lowered to 70° C. and stirred for a further 2.5 hours. The mixture was then stirred again at 90° C. for 12 hours and at room temperature for a further 12 hours. The solution was diluted with toluene as required and precipitated in ethanol (1 liter). The solid obtained was washed twice with distilled water (2×500 mL) at room temperature, filtered and finally dried to constant weight under reduced pressure (9 mbar) for 48 hours.

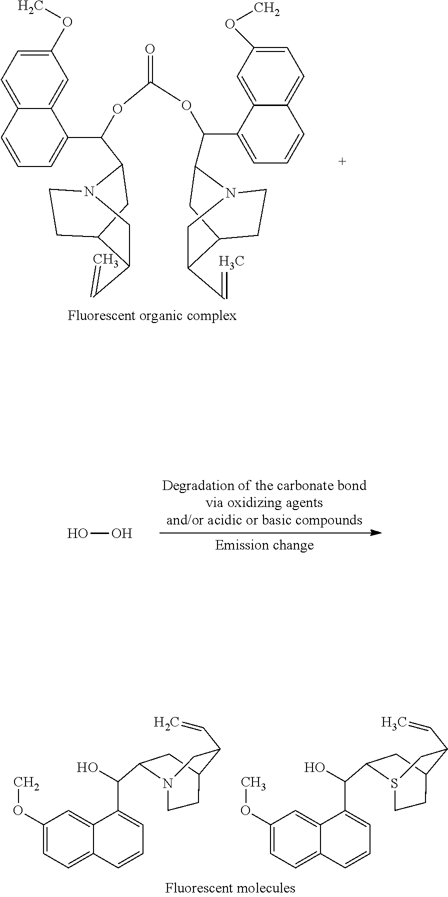

### 2. Synthesis of an Indicator Based on Hydroxycoumarin Carbonate

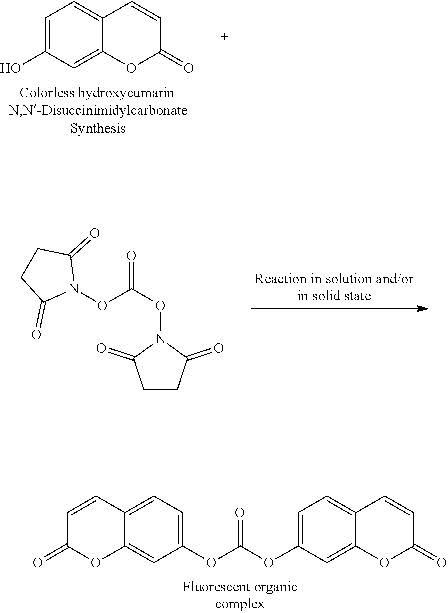 [SMILES: O=c1ccc2ccc(O)cc2o1 ; O=C(ON1C(=O)CCC1=O)ON1C(=O)CCC1=O ; O=C(Oc1ccc2ccc(=O)oc2c1)Oc1ccc2ccc(=O)oc2c1]

N,N′-disuccinic carbonate (DSC) and hydroxycoumarin were dried in vacuo for about 4 hours in separate 100 mL round-bottom flasks and then transferred to a 250 ml three-necked flask. The molar ratio of hydroxycoumarin to DSC was 2:1. The reagents were dissolved in 50 mL dry toluene under an argon atmosphere, heated to 85° C. with stirring with a KPG stirrer and refluxed at 90° C. for 6 hours. The temperature was then lowered to 60° C. and stirred for a further 2.5 hours. The mixture was then stirred again at 90° C. for 6 hours and at room temperature for a further 12 hours. The solution was diluted with toluene as required and precipitated in ethanol (1 liter). The solid obtained was washed twice with distilled water (2×500 mL) at room temperature, filtered and finally dried to constant weight under reduced pressure (9 mbar) for 48 hours.

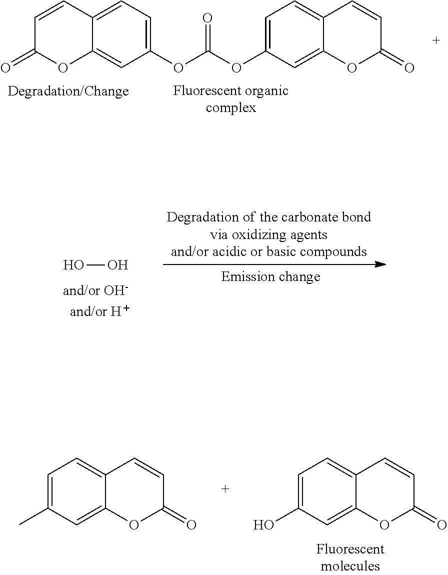

### 3. Synthesis of an Indicator Based on Hydroxycoumarin Carbamate

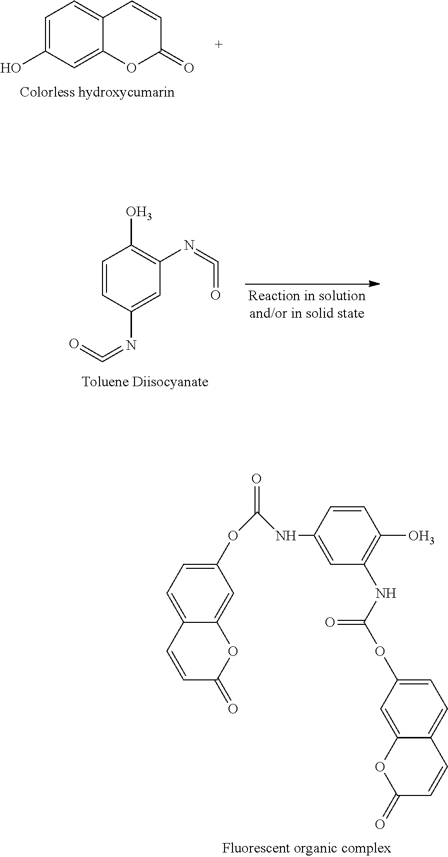 [SMILES: O=c1ccc2ccc(O)cc2o1 ; O=C=Nc1ccc(O)c(N=C=O)c1 ; O=C(Nc1ccc(O)c(NC(=O)Oc2ccc3ccc(=O)oc3c2)c1)Oc1ccc2ccc(=O)oc2c1]

Toluene-2,4-diisocyanate (TDI) and hydroxycoumarin were dried in vacuo for about 4 hours in separate 100 mL round-bottom flasks and then transferred to a 250 ml three-necked flask. The molar ratio of hydroxycoumarin to TDI was 2:1. The reagents were dissolved in 50 mL dry toluene under an argon atmosphere, heated to 75° C. with stirring with a KPG stirrer and refluxed for 12 hours. The temperature was then lowered to 70° C. and stirred for a further 2.5 hours. The mixture was then stirred at 90° C. for 10 hours and at room temperature for a further 8 hours. The solution was diluted with toluene as required and precipitated in ethanol (1 liter). The solid obtained was washed twice with distilled water (2×500 mL) at room temperature, filtered and finally dried to constant weight under reduced pressure (9 mbar) for 48 hours.

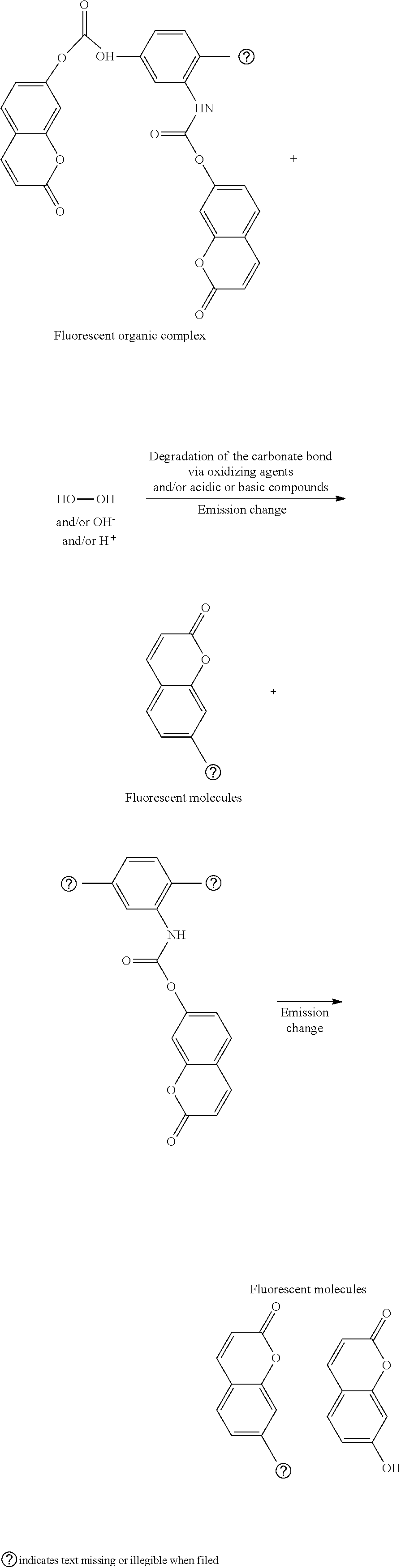

### 4. Synthesis of an Indicator Based on Tryptophan and a Trivalent Rare Earth Cation

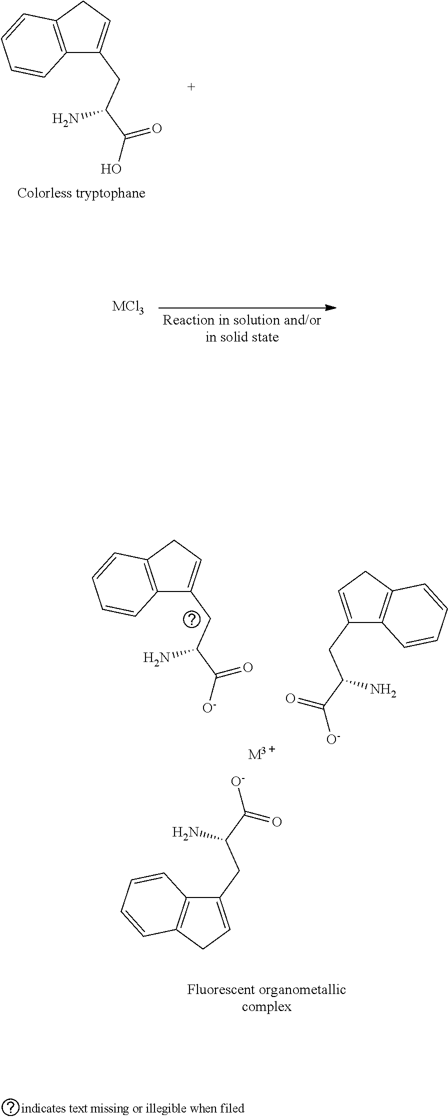

Tryptophan and lanthanide chloride were dried in vacuo for about 4 hours in separate 100 mL round-bottom flasks and later transferred to a 250 mL three-necked flask. The molar ratio of tryptophan to lanthanide chloride was 3:1. The reagents were each dissolved separately in 50 mL water. The solution of tryptophan was heated to 75° C. in a 250 mL three-necked flask with stirring at a heating rate of 10° C./h, the solution of lanthanide chloride was added dropwise over one hour and the reaction mixture was stirred for 3 hours. The temperature was then lowered to 25° C. and stirred at 40° C. for a further 2.5 hours. The mixture was then stirred at 50° C. for 1.5 hours and at room temperature for a further 3 hours. The complex compound obtained as precipitate was washed twice with distilled water (2×500 mL) at room temperature, filtered and finally dried to constant weight under reduced pressure (9 mbar) for 48 hours.

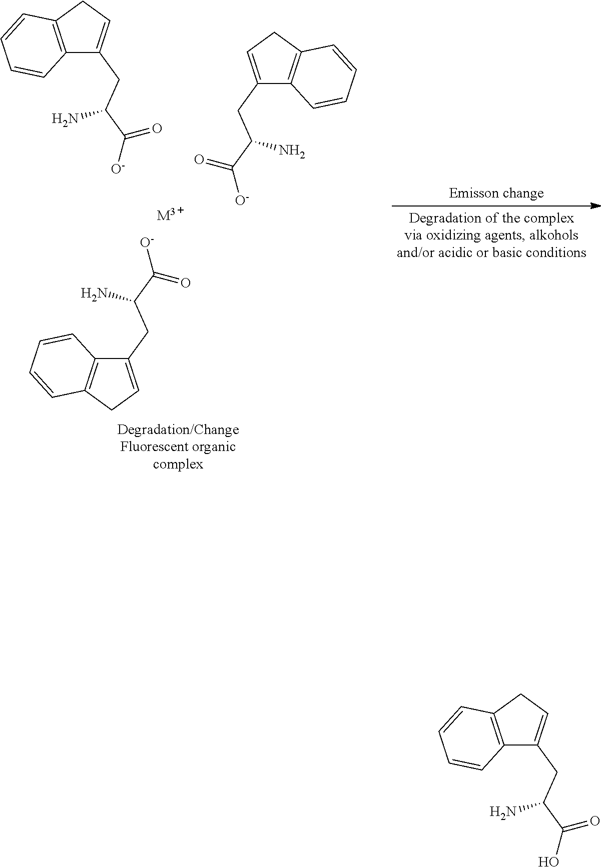

### 5. Use of Lanthanum Oxide as Indicator for Contact With Water

A tank plant for fuels was provided with a water-repellent corrosion protection coating. The coating contained 100 ppm of doped lanthanum oxide doped with ytterbium and holmium. After the application of the coating, the fluorescence of the lanthanum oxide was excited by means of planar IR irradiation and the fluorescence of the lanthanum oxide was checked visually. A uniform fluorescence indicated the uniform application of the coating. The check was repeated at regular maintenance intervals. On penetration of the coating at damage points with water, the lanthanum oxide is hydrated at the damage points. As a result of the hydration reaction, the lanthanum oxide loses its fluorescent property. These damage points therefore showed weaker or no fluorescence anymore. The coating has to be renewed at points with weaker or no fluorescence.

1. An application control composition comprising an indicator,
wherein the indicator is modifiable and comprises at least one organic compound having a conjugated binding system, an organometallic compound or an inorganic compound.

2. The composition according to claim 1, wherein the at least one organic compound having a conjugated binding system, the organometallic compound or the inorganic compound is a fluorophore.

3. The composition according to claim 2, wherein the fluorophore is selected from quinine and derivatives thereof, hydroxycoumarins and derivatives thereof, complexes of tryptophan with metals and mixtures thereof.

4. The composition according to claim 3, wherein the derivatives are carbonyl compounds, carbonates or carbamates.

5. The composition according to claim 1, wherein the indicator is modified by means of electromagnetic radiation, a pH change, a temperature change, an oxidizing agent, a reducing agent and/or contact with a biological organism.

6. The composition according to claim 1, wherein the at least one indicator has fluorescent, phosphorescent or thermochromic properties.

7. The composition according to claim 1, which is in the form of a solution, dispersion or suspension.

8. The composition according to claim 7, wherein the solution, dispersion or suspension further comprises water, alcohol or a mixture thereof.

9. A method for controlling the quality of a composition according to claim 1, comprising:
determining at least one property of the composition, wherein the property is determined by means of qualitative and/or quantitative analysis; and
matching the determined property with a target value of the property,
wherein the property of the composition is a property that changes under an external influence, wherein the external influence is one selected from the group consisting of electromagnetic radiation, pH change, temperature change, presence of an oxidizing agent, presence of a reducing agent, contact with a biological organism, and two or more thereof.

10. A method for application control comprising the steps of:
applying a composition according to claim 1 to a surface or an object;
checking the application by means of qualitative and/or quantitative analysis.

11. (canceled)

12. The composition according to claim 3, wherein the fluorophore is a complex of tryptophan with lanthanides having atomic number 57 to 71 and mixtures thereof.

13. The composition according to claim 3, wherein the fluorophore is doped lanthanum oxide.

14. The composition according to claim 5, wherein the electromagnetic radiation is selected from UV radiation, IR radiation, and visible light.

15. A method of applying the composition according to claim 1 to a substrate as one or more of a cleaning or disinfecting agent, agricultural chemical, biocide, herbicide, pesticide, coating, production aid, flux, transmission or engine oil, brake fluid or body wax, wherein the composition is applied to the substrate and the indicator is detected.
